(19) United States
(12) Patent Application Publication
(10) Pub. No.: US 2011/0086190 A1
(43) Pub. Date: Apr. 14, 2011

(54) ANTISTATIC FLEXIBLE INTERMEDIATE BULK CONTAINER

(76) Inventors: René JUD, Munchenstein (CH); Ernst MINDER, Sissach (CH); Eberhard KRAUSE, Riehen (CH)

(21) Appl. No.: 12/969,632

(22) Filed: Dec. 16, 2010

Related U.S. Application Data
(63) Continuation of application No. 10/250,963, filed on Jul. 10, 2003, now abandoned.

(30) Foreign Application Priority Data
Jan. 15, 2001 (EP) 01810035.4

(51) Int. Cl. D03D 15/00; D03D 23/00; B32B 1/02

(52) U.S. Cl. 428/36.1; 442/301; 139/383 R; 442/112

(57) ABSTRACT

The invention pertains to a woven antistatic flexible intermediate bulk container (FIBC) comprising a polyolefin fiber or strip containing as an antistatic additive a polyetheresteramide, a polyester-ether block copolymer or an antistatic composition containing said polyetheresteramide or said polyester-ether block copolymer at least partially, as warp and/or weft thread.

This is a continuation of U.S. application Ser. No. 10/250,963, pending, which is a national stage of PCT/EP01/00093, filed Jan. 8, 2002, the contents of which applications are incorporated by reference.

The present invention relates to a woven antistatic flexible intermediate bulk container (FIBC) which can safely be used with goods holding a considerable explosion risk, such as chemical powders or granules, or wheat and the like due to electrostatic charging. Further subjects of the invention are a process for preparing a woven antistatic flexible intermediate bulk container and the use of selected antistatic compositions for the antistatic treatment of woven flexible intermediate bulk containers.

It is known that polymers are subject to a strong electrostatic charge and that charges, once applied, can be discharged only slowly because of the low electrical conductivity of polymers. Rapid discharging is required not only for aesthetic reasons but also, in many cases, for reasons of safety. If the electrostatic charge is not continuously dissipated sparking may occur, caused by charges being too high, with subsequent ignition, which has already frequently resulted in serious explosions.

The insulated surface of polyolefin FIBCs can build and hold charges, often for extended periods of time. The charge normally develops on the FIBC from the flow of material during the filling or discharging process. Once sufficient charge has built up on the FIBC, a brush discharge can occur between the charged surface of the FIBC and any conductive equipment and/or personal. The discharge can have sufficient energy to ignite most solvent atmospheres and some very sensitive dust atmospheres.

It is known to limit static charging by the addition of additives that improve surface conductivity, but such substances have the disadvantage of being ineffective in practice when atmospheric humidity is low. It is therefore better to use additives that are effective at low atmospheric humidity, which can usually be achieved by increasing the volume conductivity. The known substances for increasing volume conductivity, for example carbon black or metal powder, however, alter the mechanical properties of the polymers and cannot be used for transparent polymers. In addition, there is an increasing requirement for additives to be ecologically unobjectionable.

Further details relating to antistatic additives and the mechanism of static charging may be found, for example, in the “Plastics Additives Handbook”, editors R. Gächter and H. Müller, Hanser Verlag, 3rd edition, 1990, pages 749-775.

It has now been found that woven flexible intermediate bulk containers (FIBC) can be prepared by using polyolefin fibers which contain a polyetheresteramide or a polyester-ether block copolymer as an antistatic additive as warp and/or weft threads. The charge is rapidly enough dissipated making special grounding unnecessary in many cases, thus minimizing human failures. The antistatic properties are permanent and essentially independent from humidity. Furthermore the antistatic composition does not impart any color to the fiber or strip and mechanical properties of the fibers or strips remain essentially unchanged. The FIBC can be used several times without loosing its advantageous properties.

One subject of the instant invention is therefore a woven antistatic flexible intermediate bulk container (FIBC) comprising a polyolefin fiber or strip containing as an antistatic additive a polyetheresteramide, a polyester-ether block copolymer or an antistatic composition containing said polyetheresteramide or said polyester-ether block copolymer at least partially, as warp and/or weft thread.

Typical polyolefins from which fibers or strips can be formed are mentioned below.

1. Polymers of monoolefins and diolefins, for example polypropylene, polyisobutylene, polybut-1-ene, poly-4-methylpent-1-ene, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers.

Today's FIBCs are predominantly made from polypropylene fibers or strips which is also the most preferred embodiment of the present invention.

The incorporation of the polyetheresteramide, the polyester-ether or of the antistatic composition containing said polyetheresteramide or said polyester-ether and optionally further additives into the polyolefin fibers or strips is done by known means.

The incorporation may for example be carried out in a manner known per se by mixing the said components and, if desired, further additives with the polyolefin using devices known per se, such as calenders, mixers, kneaders, extruders and the like. The additives may be added individually or in admixture with one another. It is also possible to use so-called master batches.

The antistatic polyolefin according to the present invention can be made into the desired form in known manner. Such processes include, for example extruding, spinning, injection-moulding, extrusion blow-moulding, sintering or compression/sintering.

Preferably the fibers or strips are formed by spinning or extrusion blow molding.

The manufacture of polyolefin fibers and strips is for example described in Saechtling, Kunststoff Taschenbuch 21. Ausgabe, 1979, Seite 226.

Particularly preferred are strips which are obtained by cutting extrusion blow molded films in the desired dimensions.

The fiber thickness can be adjusted over a wide range and is typically from 10μ to 2000μ If strips are formed they have usually a thickness of 10μ to 1000μ preferably of 100μ to 800μ more preferably of 100μ to 600μ and a width of 0.5 mm to 50 mm, preferably of 1 mm to 20 mm and more preferably of 1 mm to 5 mm.

The woven fabric can have any type of texture.

The weight of the woven fabric is preferably from 100 g/m²to 500 g/m², more preferably from 100 g/m²to 400 g/m².

Preferably the antistatic additive is present in an amount of from 5%-100%, more preferably of from 7%-30% based on the weight of the polyolefin.

A particular advantage of the present invention is that not every warp or weft thread needs to be antistatic. For many applications it may be sufficient to have for example every second third or fourth warp and/or weft thread antistatic. Also other combinations are possible. How many warp and/or weft threads should contain the antistatic additive depends on the end use of the FIBC and can be found out by appropriate experiments. Usually it should not be less than every 50^{th} warp and/or weft thread.

Preferred is a woven antistatic flexible intermediate bulk container wherein at least each 20^{th} warp and/or weft thread contains the antistatic additive.

In a more preferred embodiment of the invention each 5^{th} or more warp and/or weft thread is made from the antistatic polyolefin.

If the antistatic polyolefin is used in each warp and weft thread, a particularly conductive FIBC is obtained.

The amount of antistatic cross-over points of warp and weft threads is one factor defining the final conductivity of the FIBC, thus allowing to adjust individually the desired conductivity.

The FIBC can contain additionally a coating, which optionally contains also the antistatic additive. The coating can be inside and/or outside of the FIBC. It is also possible that the FIBC is only partially coated on one or both surfaces, preferably one half is then coated.

Preferred is a woven antistatic flexible intermediate bulk container wherein the antistatic additive is a polyetheresteramide or an antistatic composition containing said polyetherester-amide.

Also preferred is a woven antistatic flexible intermediate bulk container which has a coating on the inner and/or outer surface containing said antistatic additive in an amount of 7%-30% based on the solid weight of the coating.

More preferably the coating is only on the inside of the FIBC.

In some cases it may be possible to achieve antistatic properties with an antistatic coating even if the fabric of the FIBC does not contain an antistatic additive.

Yet another aspect of the invention is therefore a woven antistatic flexible intermediate bulk container (FIBC) comprising a fabric made from a polyolefin fiber or strip which fabric has a coating on the inner and/or outer surface containing as an antistatic additive a polyetheresteramide, a polyester-ether block copolymer or an antistatic composition containing a polyetheresteramide or a polyester-ether block copolymer in an amount of 7%-30% based on the solid weight of the coating.

Typically the coating has a weight of 10 g/m²to 100 g/m², more preferably of 10 g/m²to 50 g/m².

The coating can be made from a thermoplastic polymer such as from a polyolefin, which is applied from the melt for example as a laminate or it may be made from a thermosetting or other crosslinkable polymer, which may be applied for example by dipping, brushing or spraying.

When a thermoplastic polymer is used polypropylene and polyethylene are preferred.

It is also possible to laminate the fabric which has been treated with the antistatic agent with paper or aluminium. This is done preferably on the inside of the FIBC. If paper is used it may also contain the antistatic additive.

Examples for suitable coatings and paints are the following:

1. paints based on cold- or hot-crosslinkable alkyd, acrylate, polyester, epoxy or melamine resins or mixtures of such resins, if desired with addition of a curing catalyst;

2. two-component polyurethane paints based on hydroxyl-containing acrylate, polyester or polyether resins and aliphatic or aromatic isocyanates, isocyanurates or polyisocyanates;

3. one-component polyurethane paints based on blocked isocyanates, isocyanurates or polyisocyanates which are deblocked during baking, if desired with addition of a melamine resin;

4. one-component polyurethane paints based on a trisalkoxycarbonyltriazine crosslinker and a hydroxyl group containing resin such as acrylate, polyester or polyether resins;

5. one-component polyurethane paints based on aliphatic or aromatic urethaneacrylates or polyurethaneacrylates having free amino groups within the urethane structure and melamine resins or polyether resins, if necessary with curing catalyst;

6. two-component paints based on (poly)ketimines and aliphatic or aromatic isocyanates, isocyanurates or polyisocyanates;

7. two-component paints based on (poly)ketimines and an unsaturated acrylate resin or a polyacetoacetate resin or a methacrylamidoglycolate methyl ester;

8. two-component paints based on carboxyl- or amino-containing polyacrylates and polyepoxides;

9. two-component paints based on acrylate resins containing anhydride groups and on a polyhydroxy or polyamino component;

10. two-component paints based on acrylate-containing anhydrides and polyepoxides;

11. two-component paints based on (poly)oxazolines and acrylate resins containing anhydride groups, or unsaturated acrylate resins, or aliphatic or aromatic isocyanates, isocyanurates or polyisocyanates;

12. two-component paints based on unsaturated polyacrylates and polymalonates;

13. thermoplastic polyacrylate paints based on thermoplastic acrylate resins or externally crosslinking acrylate resins in combination with etherified melamine resins;

14. paint systems based on siloxane-modified or fluorine-modified acrylate resins;

15. paint systems, especially for clearcoats, based on malonate-blocked isocyanates with melamine resins (e.g. hexamethoxymethylmelamine) as crosslinker (acid catalyzed);

As an alternative to the above mentioned coating it is also possible to equip the FIBC with an inner bag which is not necessarily completely fixed to the fabric of the FIBC. This inner bag contains also a polyetheresteramide or an antistatic composition containing a polyetheresteramide and is for example form welded with the FIBC. The inner bag may be made from a synthetic polymer, preferably from a polyolefin or from a cellulosic material such as paper or cotton. Examples for polyolefins have been already mentioned.

Preferred is a woven antistatic flexible intermediate bulk container wherein an inner bag made from a polyolefin film is loose or partly fixed to the fabric and contains said antistatic additive.

The antistatic additive can be incorporated by standard methods into the inner bag, examples have been already given above. In case of cellulosic materials the antistatic additive can be mixed with an appropriate solvent and applied by spraying or dipping and subsequent evaporation of the solvent. It is also possible to apply it by roller coating. If a solvent is applied the antistatic additive is in the form of a suspension and not dissolved.

The FIBC may also additionally be equipped with conductive or “quasi-conductive” fibers, which may be in the warp or weft threads. Examples for conductive fibers are carbon fibers or metal fibers. The metal may be for example Fe, Ni, steel or silver. Examples for “quasi-conductive” fibers are given in U.S. Pat. No. 5,478,154.

The antistatic additive contains a polyetheresteramide or a polyester-ether block copolymer. U.S. Pat. No. 4,332,920 describes suitable polyetheresteramides and their manufacture. In EP-A-0 613 919 certain polyetheresteramides containing a bisphenol A unit are proposed as antistatic additives for thermoplastic polymers. DE 28 37 687 describes a process for the preparation of such polyetheresteramides and GB 1 518 060 discloses their use as antistatic fibers and filaments.

U.S. Pat. No. 6,140,405 describes electrostatic dissipative polymers on the basis of polyester-ether block copolymers and also polyetheresteramides, which are suitable for the present invention.

Preferred polyester-ether block copolymers comprise the reaction product of ethylene glycol, therephthalic acid or dimethyl terephthalate and polyethylene glycol. These and other examples of other polyester-ether copolymers which can be utilized are set forth in Encyclopedia of Polymer Science and Engineering, Vol. 12, John Wiley & Sons, Inc. NY, 1988, pages 49-52.

Particularly suitable polyetheresteramides and polyester-ethers are commercially available for example from Elf Atochem Corp. under the trade name Pebax®, from Sanyo Chem. Corp. under the trade name Pelestat®, from B. F. Goodrich Company under the trade name Stat-Rite® and from Dupont Company under the trade name Hytrel®.

Preferred is an antistatic composition containing a polyetheresteramide. Such compositions are described in U.S. Pat. No. 5,965,206.

Preferred compositions contain a fiber-forming or fibrous organic polymeric material together with a polyetheresteramide or a polyester-ether block copolymer which is capable of ion conduction and can be so incorporated into the polyolefin that the polyetheresteramide or the polyester ether block copolymer is substantially adsorptively bound to the fiber or dissolved in it and together with it forms a network in the polyolefin substrate in which the fiber is not soluble. A portion of the polyetheresteramide or of the polyester-ether block copolymer capable of ion conduction has polar groups that are capable of complexing or solvating a salt of an inorganic or organic protonic acid.

The fibrous or fiber-forming organic polymeric material must be so selected that it does not dissolve in the polyolefin substrate but is able to form a net-like structure of contiguous fibers.

For good electrical conductivity it is advantageous for the fibers of the organic material to be contiguous with one other or to cross one another at as many sites as possible once they have been incorporated in the polymer. By that means electrically conductive paths are formed through which the charges can flow away.

Since the fibers and the polymers or copolymers capable of ion conduction are high-molecular-weight compounds, there is also virtually no risk of their being exuded, with the result that the antistatic property is especially durable.

The stability properties of the polymer, such as thermostability and resistance to light and hydrolysis, are in most cases virtually unaffected.

Preferably the antistatic additive is a mixture in the form of contiguous fibers, which mixture comprises

(b1) an organic polymeric material that is fibrous or forms fibers on mixing and is not soluble in the polyolefin substrate which is selected from the group consisting of a polyacrylic acid ester, polymethacrylic acid ester, polyacrylonitrile, polyvinyl alcohol, polyvinyl acetate, polyamide, polyurethane or polyester;

(b2) a polyetheresteramide or a polyester-ether block copolymer; and

(b3) a salt selected from the group consisting of LiClO₄, LiCF₃SO₃, NaClO₄, LiBF₄, NaBF₄, KBF₄, NaCF₃SO₃, KClO₄, KPF₆, KCF₃SO₃, KC₄F₉SO₃, Ca(ClO₄)₂, Ca(PF₆)₂, Mg(ClO₄)₂, Mg(CF₃SO₃)₂, Zn(ClO₄)₂, Zn(PF₆)₂ or Ca(CF₃SO₃)₂, that has been complexed or solvated in the polyetheresteramide or in the polyester-ether block copolymer (b2).

Most preferred is a mixture in the form of contiguous fibers, which mixture comprises

(b1) 30-70% by weight of a polyamide;

(b2) 70-30% by weight of a polyetheresteramide or a polyester-ether block copolymer; and

(b3) 0.1-10% by weight of a salt selected from the group consisting of LiClO₄, LiCF₃SO₃, NaClO₄, LiBF₄, NaBF₄, KBF₄, NaCF₃SO₃, KClO₄, KPF₆, KCF₃SO₃, KC₄F₉SO₃, Ca(ClO₄)₂, Ca(PF₆)₂, Mg(ClO₄)₂, Mg(CF₃SO₃)₂, Zn(ClO₄)₂, Zn(PF₆)₂ or Ca(CF₃SO₃)₂, that has been complexed or solvated in the polyetheresteramide or in the polyester-ether block copolymer (b2), the sum of the components giving 100%.

Such antistatic compositions are commercially available from Ciba Specialty Chemicals Company under the trade name Irgastat® P18 and Irgastat® P22.

The antistatic mixture may contain in addition further additives, such as processing, light and heat stabilizers. Examples are given below.

1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethyl-phenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis-(3,5-di-tert-butyl-4-hydroxyphenyl)adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis-(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-nnethylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl) butyrate], bis(3-tent-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis-(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxy-benzyl)sulfide, isooctyl-3,5-di-tert-butyl-4-hydroxybenzylmercaptoacetate.

1.8. Hydroxybenzylated malonates, for example dioctadecyl-2,2-bis-(3,5-di-tert-butyl-2-hydroxybenzyl)-malonate, di-octadecyl-2-(3-tert-butyl-4-hydroxy-5-methylbenzyl)-malonate, di-dodecylmercaptoethyl-2,2-bis-(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris-(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)-isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)-isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard® XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene, N,N-bis(2,2,6,6-tetramethylpiperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

2. UV Absorbers and Light Stabilisers

2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tent-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyL)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]-benzotriazole; 2-[2′-hydroxy-3′-(1,1,3,3-tetramethylbutyl)-5′-(α,α-dimethylbenzyl)-phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, as for example 4-tert-butyl-phenyl salicylate, phenyl salicylate, octylphenyl salicylate, dibenzoyl resorcinol, bis(4-tert-butylbenzoyl)-resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxy-cinnamate, butyl α-cyano-β-methyl-p-methoxy-cinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thio-bis-[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenyl-undecylketoxime, nickel complexes of 1-phenyl-4-lauroyl-5-hydroxypyrazole, with or with-out additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-di-chloro-1,3,5-triazine, tris(2,2,6,6-tetramethyl-4-piperidyl)nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl-)-1,3,5-triazine and 1,2-bis(3-aminopropylamino)-ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensation product of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin_-copolymer with 2,2,6,6-tetramethyl-4-aminopiperidine or 1,2,2,6,6-pentamethyl-4-aminopiperidine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyl-oxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxy-propoxy)phenyl]-4,6-bis(2,4-dimethyl)-1,3,5-triazine, 2-[2-hydroxy-4-(2-hydroxy-3-octyloxy-propyloxy)phenyl]-4,6-bis(2,4-dimethyl)-1,3,5-triazine, 2-[4-(dodecyloxy/tridecyloxy-2-hydroxypropoxy)-2-hydroxy-phenyl]-4,6-bis(2,4-dimethylphenyl)-1,3,5-triazine, 2-[2-hydroxy-4-(2-hydroxy-3-dodecyloxy-propoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

3. Metal deactivators, for example N,N′-diphenyloxamide, N-salicylal-N′-salicyloyl hydrazine, N,N′-bis(salicyloyl)-hydrazine, N,N′-bis(3,5-di-tert-butyl-4-hydroxyphenylpropionyl)-hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenyl-alkyl phosphites, phenyl-dialkyl phosphites, tris(nonylphenyl) phosphite, trilauryl phosphite, trioctadecyl phosphite, distearyl-pentaerythritol diphosphite, tris(2,4-di-tert-butylphenyl) phosphite, diisodecyl pentaerythritol diphosphite, bis(2,4-di-tert-butylphenyl)-pentaerythritol diphosphite, bis(2,4-di-cumylphenyl)-pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)-methyl phosphite, bis(2,4-di-tert-butyl-6-methylphenyl)-ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl) phosphite (Irgafos® 168, Ciba-Geigy), tris(nonylphenyl)phosphite,

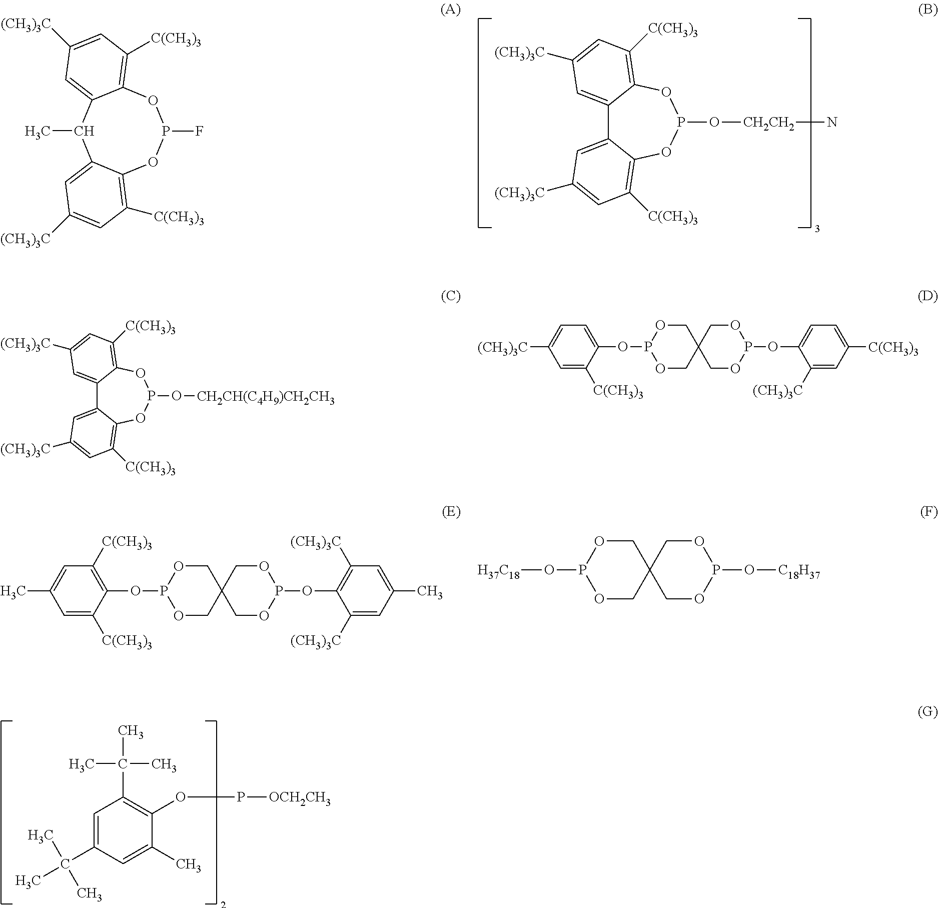

5. Hydroxylamines, for example, N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example, N-benzyl-alpha-phenyl-nitrone, N-ethyl-alpha-methyl-nitrone, N-octyl-alpha-heptyl-nitrone, N-lauryl-alpha-undecyl-nitrone, N-tetradecyl-alpha-tridecyl-nitrone, N-hexadecyl-alpha-pentadecyl-nitrone, N-octadecyl-alpha-heptadecyl-nitrone, N-hexadecyl-alpha-heptadecyl-nitrone, N-ocatadecyl-alpha-pentadecyl-nitrone, N-heptadecyl-alpha-hepta-decyl-nitrone, N-octadecyl-alpha-hexadecyl-nitrone, nitrone derived from N,N-dialkylhydroxyl-amine derived from hydrogenated tallow amine.

7. Thiosynergists, for example, dilauryl thiodipropionate or distearyl thiodipropionate.

8. Peroxide scavengers, for example esters of 3-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(β-dodecylmercapto)propionate.

9. Polyamide stabilisers, for example, copper salts in combination with iodides and/or phosphorus compounds and salts of divalent manganese.

10. Basic co-stabilisers, for example, melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example, inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyldibenzylidene)sorbitol, and 1,3:2,4-di(benzylidene)sorbitol.

12. Fillers and reinforcing agents, for example, calcium carbonate, silicates, glass fibers, glass bulbs, asbestos, talc, kaolin, mica, barium sulfate, metal oxides and hydroxides, carbon black, graphite, wood flour and flours or fibers of other natural products, synthetic fibers.

13. Other additives, for example, plasticisers, lubricants, emulsifiers, pigments, rheology additives, catalysts, flow-control agents, optical brighteners, flameproofing agents, further antistatic agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839 or EP-A-0591102 or 3-[4-(2-acetoxyethoxy)-phenyl]-5,7-di-tert-butylbenzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tent-butylbenzofuran-2-one, 3-(2,3-dimethylphenyl)-5,7-di-tert-butylbenzofuran-2-one.

A further subject of the present invention is a process for manufacturing a woven antistatic flexible intermediate bulk container, comprising

incorporating into a polyolefin fiber or strip as antistatic additive a polyetheresteramide, a polyester-ether block copolymer or an antistatic composition containing a polyetherester-amide or a polyester-ether block copolymer and

using said polyolefin fiber or strip at least in part as warp and/or weft thread in weaving the fabric.

Still another subject of the invention is the use of a polyetheresteramide, a polyester-ether block copolymer or an antistatic composition containing a polyetheresteramide or a polyester-ether block copolymer as antistatic additive for manufacturing a woven antistatic flexible intermediate bulk container, comprising incorporating it into a polyolefin fiber or strip and weaving said polyolefin fiber or strip at least in part as warp and/or weft thread into a fabric.

The definitions and preferences given above apply also for the process and use.

The following examples illustrate the invention.
Fabric: 200 g/m², produced by Debant, Turkey
Polypropylene: Type: F401-Z
   Producer: Polski Kancern Naftowy ORLEN SA, Poland
   each 4^{th} fiber in warp thread contains 15% by weight Irgastat P 18
   each 4^{th} fiber in weft thread contains 15% by weight Irgastat P 18

Irgastat® P18 and Irgastat® P22 are antistatic additives commercially available from Ciba Specialty Chemicals Inc.

| | | | |
|---|---|---|---|
| | DENIER | WIDTH | THICKNESS |
| Type | denier | mm | μm |

WEFT

| | | | |
|---|---|---|---|
| STANDARD | 1279 | 3 | 51 |
| 15% P 18 | 1292 | 2.95 | 59 |

WARP

| | | | |
|---|---|---|---|
| STANDARD | 1778 | 3.05 | 71 |
| 15% P 18 | 1924 | 2.95 | 77 |

Texture of fabric: Stahlinger type woven

Coating with 25% P22 one side (inside), 20 g/m²:

| Resin Type | PP |
|---|---|
| Producer | Elenac Polyethylene, Deutschland |
| Brand | Lupolen 2424 HK |
| Type No | 2426 H |
| MFI (gr/10′) | 1.88 |

Testing: A discharge test according to VDI Reports No. 1272 of 1996 is performed the result is presented in Table 1

TABLE 1

| Experiment No. | Antistatic Equipment | Result |
|---|---|---|
| 1 control | above fabric without Irgastat | >100 nC |
| 2 | above fabric with 15% Irgastat P 18 | <30 nC, does not ignite |
| | | incentive propane/air mixture |
| 3 | above fabric with 15% Irgastat P 18 | <30 nC, does not ignite |
| | and inner side coating with 25% | incentive propane/air mixture |
| | Irgastat P 22 | |

The ignition test is further described for example in Journal of Electrostatics, 30 (1993) 115-122 and in Inst. Phys. Conf. Ser. No. 143, page 121-124; presented Apr. 2-5, 1995 at the 9^{th} Int. Conf. on Electrostatics.

1. A woven antistatic fabric, useful in a woven flexible intermediate bulk container (FIBC), said fabric comprising a polyolefin fiber or strip containing as an antistatic additive a polyetheresteramide, a polyester-ether block copolymer or an antistatic composition containing said polyetheresteramide or said polyester-ether block copolymer at least partially, as warp and/or weft thread.

2. A woven antistatic fabric according to claim 1 wherein the polyolefin is polypropylene.

3. A woven antistatic fabric according to claim 1 wherein at least each 20^{th} warp and/or weft thread contains the antistatic additive.

4. A woven antistatic fabric according to claim 1 wherein the antistatic additive is present in an amount of from 7%-30% based on the weight of the polyolefin.

5. A woven antistatic fabric according to claim 1 wherein the antistatic additive is a polyetheresteramide or an antistatic composition containing said polyetheresteramide.

6. A woven antistatic fabric according to claim 1 which has a coating on the inner and/or outer surface containing said antistatic additive in an amount of 7%-30% based on the solid weight of the coating.

7. A woven antistatic fabric according to claim 1 wherein an inner bag made from a polyolefin film is loose or is partly fixed to the fabric and contains said antistatic additive.

8. A woven antistatic fabric according to claim 1 wherein the antistatic additive composition comprises
b1) a fiber-forming or fibrous organic polymeric material,
b2) a polyetheresteramide or a polyester-ether block copolymer which is capable of ion conduction and can be so incorporated into the polyolefin that the polyetheresteramide or the polyester-ether block copolymer is substantially adsorptively bound to the fiber b1) or dissolved in it and together with it forms a network in the polyolefin substrate in which the fiber is not soluble and
b3) a salt of an inorganic or organic protonic acid which is complexed or solvated in the polyetheresteramide or in the polyester-ether block copolymer b2).

9. A woven antistatic fabric according to claim 8 wherein the antistatic additive composition is a mixture in the form of contiguous fibers, which mixture comprises
(b1) an organic polymeric material that is fibrous or forms fibers on mixing and is not soluble in the polyolefin substrate and which is selected from the group consisting of a polyacrylic acid ester, polymethacrylic acid ester, polyacrylonitrile, polyvinyl alcohol, polyvinyl acetate, polyamide, polyurethane and a polyester;
(b2) a polyetheresteramide or a polyester-ether block copolymer; and
(b3) a salt selected from the group consisting of LiClO₄, LiCF₃SO₃, NaClO₄, LiBF₄, NaBF₄, KBF₄, NaCF₃SO₃, KClO₄, KPF₆, KCF₃SO₃, KC₄F₉SO₃, Ca(ClO₄)₂, Ca(PF₆)₂, Mg(ClO₄)₂, Mg(CF₃SO₃)₂, Zn(ClO₄)₂, Zn(PF₆)₂ and Ca(CF₃SO₃)₂, that has been complexed or solvated in the polyetheresteramide or in the polyester-ether block copolymer (b2).

10. A woven antistatic fabric according to claim 9 wherein the antistatic additive is a mixture in the form of contiguous fibers, which mixture comprises
(b1) 30-70% by weight of a polyamide;
(b2) 70-30% by weight of a polyetheresteramide or a polyester-ether block copolymer; and
(b3) 0.1-10% by weight of a salt selected from the group consisting of LiClO₄, LiCF₃SO₃, NaClO₄, LiBF₄, NaBF₄, KBF₄, NaCF₃SO₃, KClO₄, KPF₆, KCF₃SO₃, KC₄F₉SO₃, Ca(ClO₄)₂, Ca(PF₆)₂, Mg(ClO₄)₂, Mg(CF₃SO₃)₂, Zn(ClO₄)₂, Zn(PF₆)₂ and Ca(CF₃SO₃)₂, that has been complexed or solvated in the polyetheresteramide or in the polyester-ether block copolymer (b2), the sum of the components giving 100%.

11. A process for manufacturing a woven antistatic fabric, useful in a flexible intermediate bulk container, the process comprising
incorporating into a polyolefin fiber or strip as antistatic additive a polyetheresteramide, a polyester-ether block copolymer or an antistatic composition containing a polyetherester-amide or a polyester-ether block copolymer and
weaving said polyolefin fiber or strip at least in part as warp and/or weft thread into the fabric.

12. A woven antistatic fabric, useful in a woven flexible intermediate bulk container (FIBC) said fabric comprising a polyolefin fiber or strip which fabric has a coating on the inner and/or outer surface containing as an antistatic additive a polyetheresteramide, a polyester-ether block copolymer or an antistatic composition containing a polyetheresteramide or a polyester-ether block copolymer in an amount of 7%-30% based on the solid weight of the coating.
